(19) United States
(12) Patent Application Publication
(10) Pub. No.: US 2013/0038900 A1
(43) Pub. Date: Feb. 14, 2013

(54) PROCESSING A FILE FOR PRINTING

(71) Applicants: Shaun Henry, Middleton, ID (US); Fabio Giannetti, Los Gatos, CA (US)

(72) Inventors: Shaun Henry, Middleton, ID (US); Fabio Giannetti, Los Gatos, CA (US)

(21) Appl. No.: 13/207,270

(22) Filed: Aug. 10, 2011

(51) Int. Cl. G06F 15/00

(52) U.S. Cl. 358/1.15

(57) ABSTRACT

Methods and systems are disclosed for processing a file having a plurality of pages for printing by: for each page in the file, determining whether to perform a trapping function on that page; and distributing the pages in the file among a plurality of parallel raster image processors based on the determination for each page of whether to perform the trapping function.

### BACKGROUND

In typical printing systems, a print job is received from a source as a file formatted according to a page description language (PDL) understood by the printing system. Prior to printing, one or more raster image processors (RIPs) generally convert the print job file into a raster image recognized by a printing device. Often the print job file undergoes various additional processing prior to or during the rasterization process to adapt the print job for optimal printing by a particular printing device. This additional processing occurs pre-press, that is, prior to the print job being printed on a physical medium.

Trapping is one such pre-press processing function. Trapping is a color management technique in which small overlaps are created between abutting colors in an image to be printed in order to mask potential misalignment issues on the printing device. In general, trapping is performed at one of two stages of the printing process: (1) during a conversion of the print job to a page description language file; or (2) during rasterization by one or more raster image processors.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a block diagram of an illustrative printing system, according to one example of principles described herein.

FIG. 2 is a block diagram of an illustrative job profiling module in an illustrative printing system, according to one example of principles described herein.

FIG. 3 is a block diagram of an illustrative partitioning module in an illustrative printing system, according to one example of principles described herein.

FIG. 4 is a block diagram of an illustrative aggregation module in an illustrative printing system, according to one example of principles described herein.

FIG. 5 is a flowchart diagram of an illustrative method of processing a file for printing, according to one example of principles described herein.

FIG. 6 is a flowchart diagram of an illustrative method of processing a file for printing, according to one example of principles described herein.

FIG. 7 is a block diagram of an illustrative computing device, according to one example of principles described herein.

Throughout the drawings, identical reference numbers designate similar, but not necessarily identical, elements.

### DETAILED DESCRIPTION

As described above, trapping can be a useful pre-press tool. By discretely modifying a print job image to compensate for potential printing device misalignment issues, the overall aesthetic quality of printed image may increase. Often trapping functions may be performed at the rasterization stage of printing by one or more parallel raster image processors (RIPs). However, prior solutions for distributing print jobs to parallel RIPs can be quite inefficient. For example, many prior solutions simply assign each print job to a single, separate RIP. However, if trapping is to be performed on that particular print job, the raster image processing time may significantly increase, thereby reducing the print job throughput. This reduced print job throughput may, in turn, result in an underutilization of the printing device. In other prior solutions, a print job may be divided into partitions and distributed among multiple RIPs without taking into account the impact of trapping on RIP processing resources. This configuration may also result in a reduced print job throughput.

In view of the above and other considerations, the present specification discloses methods, systems, and computer program products for processing a multi-page file, such as a Page Description Language (PDL) file, for printing. In these methods, systems, and computer program products, a determination is made for each page of the file of whether a trapping function is to be performed on that page. The collective determinations may be attached to the file as metadata, and the pages of the file are distributed among multiple parallel RIPs based on which pages are to undergo trapping processing.

For example, the pages may be distributed such that pages indicated for trapping receive more RIP processing resources and pages not indicated for trapping receive fewer RIP processing resources. By increasing the RIP processing resources allocated to pages indicated for trapping, rasterization and trapping functions may be performed on the pages more efficiently, thereby allowing these functions to be completed at or above printing speed.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples. The various instances of the phrase “in one example” or similar phrases in various places in the specification are not necessarily all referring to the same example.

As used in the present specification and claims, the term “processor” refers to hardware circuitry capable of executing stored executable code.

As used in the present specification and claims, the term “module” or “submodule” refers to one or more elements of functionality implemented by a machine, such as a processor.

As used in the present specification and claims, the term “raster image processor” or “RIP” refers to hardware circuitry, or software implemented by hardware circuitry, that accepts a page description language file as input and produces a raster or bitmap image from the page description language file for output to a printing device.

As used in the present specification and claims, the term “page” refers to a single physical medium on which an image is printed or a digital representation of the image to be printed on a single physical medium. The image to be printed may include text, graphical data, or a combination of text and graphical data.

As used in the present specification and claims, the term “trapping function” refers to a prepress technique in which small overlaps are created between abutting colors to compensate for potential registration or alignment imperfections in a printing device.

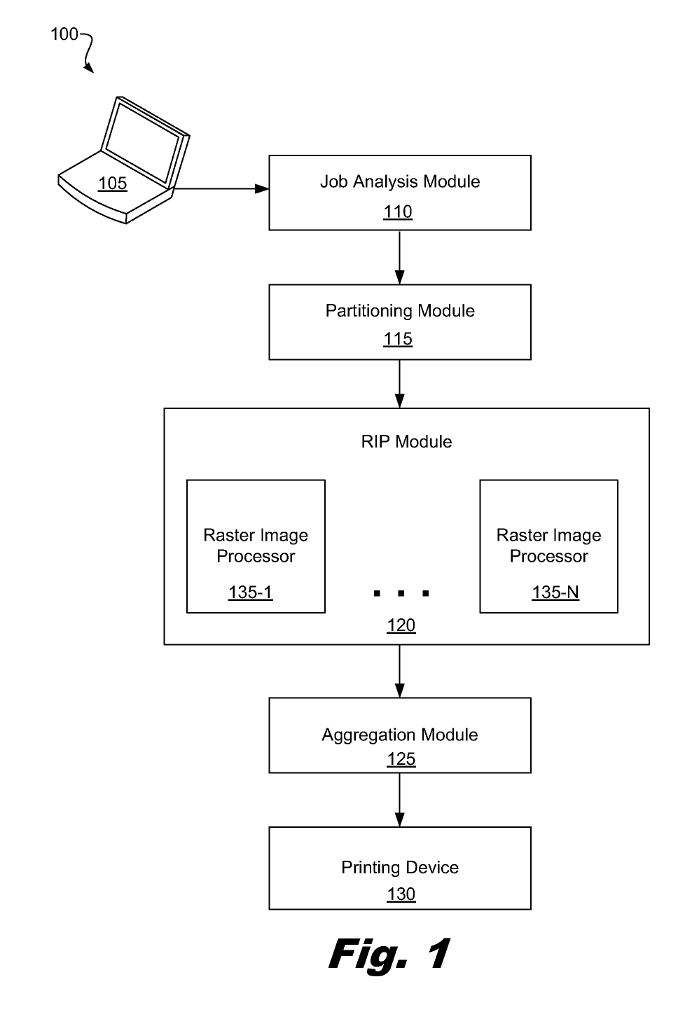

Turning now to the Figures, FIG. 1 is a block diagram of an illustrative system (100) for printing a file. The system (100) includes a print job source (105), a job analysis module (110), a partitioning module (115), a raster image processing module (120), an aggregation module (125), and a printing device (130). The print job source (105) may include a computer and/or a computer-implemented application that is communicatively coupled to the job analysis module (110).

Each of the job analysis module (110), the partitioning module (115), the raster image processing module (120), and the aggregation module (125) may be implemented by one or more machines executing machine-readable instructions to perform a desired functionality. In the event that multiple machines are used to implement one or more of the modules (110, 115, 120, 125), the machines may execute portions of the modular functionality in serialized or parallel fashion, as may suit a particular implementation of the principles of the present specification. The printing device (130) may be a conventional or special-purpose electronic printing device (130), such as a digital printing press, a laser printer, an inkjet printer, or similar device.

In certain examples, each of the job analysis module (110), the partitioning module (115), the raster image processing module (120), and the aggregation module (125) may be implemented by circuitry packaged with the printing device (130). Alternatively, one or more of these modules (110, 115, 120, 125) may be packaged separately from the printing device (130).

Furthermore, in certain examples the same processing circuitry may implement one or more of the job analysis module (110), the partitioning module (115), the raster image processing module (120), and the aggregation module (125). Additionally or alternatively, dedicated circuitry may be used to implement a single module (110, 115, 120, 125).

A print job is produced as a page description language (PDL) file by the print job source (105). A page description language is a language that describes the appearance of a printed page in a format understood by the printing device (130). Any page description language that suits a particular application of the principles herein may be used by the print job source (105) to create the page description language file.

The print job source (105) provides the page description language file to a job analysis module (110). The page description language file may include a number of pages to be printed. The job analysis module (110) receives the page description language file and performs an analysis of the content of each of the pages to determine whether or not a trapping function should be performed on each of the pages. In particular, the job analysis module (110) may look for the existence of abutting colors in each page and determine whether the proximity of those colors warrants trapping. The job analysis module (110) may further append information about which pages in the page description language file warrant trapping to the page description language file as metadata for use by other modules in the system (100).

The job analysis module (110) may then present the page description language file with its accompanying metadata to the partitioning module (115). The partitioning module (115) divides the page description language file into multiple partitions based on the trapping metadata produced by the job analysis module (110). Each partition may include one or more pages from the page description language file. Each partition is assigned to an individual raster image processor (135-1 to 135-N) in the raster image processor module for parallel raster image processing.

In certain examples, the partitioning module (115) may use the trapping metadata to determine how to partition the job in order to maximize throughput at the printing device (130) by reducing the overall time to perform raster image processing on the print job. Thus, in an illustrative print job having a mix of pages indicated for trapping and pages not indicated for trapping, the partitioning module (115) may assign the pages indicated for trapping to smaller partitions and the pages not indicated for trapping to larger partitions.

In this way, because the partitions are assigned in parallel to raster image processors, relatively more processing resources can be dedicated to pages indicated for trapping than to pages not indicated for trapping. Due to the processing intensive nature of trapping functions, this distribution may substantially increase the efficiency of resource allocation, thereby speeding up raster image processing for the print job as a whole, and reducing the idle time of the printing device (130).

The aggregation module (125) receives the raster images output from the individual raster image processors (135-1 to 135-N), organizes them into a consecutive order according to the original order of the pages in the page description language file output by the print job source (105), and outputs the raster images of the pages to the printing device (130) in the consecutive order.

In one example, the print job source (105) may provide a page description language job with 20 pages, where pages 1-5 and 12-17 contain objects for which trapping should be performed. The remaining pages 6-11 and 18-20 do not contain objects necessitating trapping. The raster image processing module (120) of the system (100) may include 18 separate raster image processors (135-1 to 135-N) (e.g., N=18), which is typical for a digital printing press. In this example, the job analysis module (110) may receive the page description language file from the print job source (105), analyze each page in the page description language file, and determine that trapping will be performed on pages 1-5 and 12-17. This information is then appended to or associated with the page description language file as metadata.

Continuing with this example, the partitioning module (115) may then receive the page description language file and trapping metadata from the job analysis module (110) and use the trapping metadata to divide the page description language file into 13 separate partitions. Each of pages 1, 2, 3, 4, 5, 12, 13, 14, 15, 16, and 17 (i.e., the pages indicated for trapping) may be submitted to a separate raster image processor (135-1 to 135-N) as its own partition. By contrast, the pages not indicated for trapping may be grouped together in the remaining partitions, with pages 6-11 being submitted to a separate raster image processor (135-1 to 135-N) as the 12th partition, and pages 18-20 being submitted to a separate raster image processor (135-1 to 135-N) as the 13th partition.

Thus, for this print job, 13 of the 18 raster image processors (135-1 to 135-N) in the raster image processing module (120) are used to perform raster image processing on the individual pages. These 13 raster image processor (135-1 to 135-N) may perform raster image processing on their assigned partitions in parallel. By partitioning the print job such that the pages indicated for trapping are allocated more raster image processing resources than pages not indicated for trapping, the resource utilization efficiency of the raster image processors (135-1 to 135-N) is optimized, and the raster image processing is completed for the print job at or above the printing speed of the printing device (130).

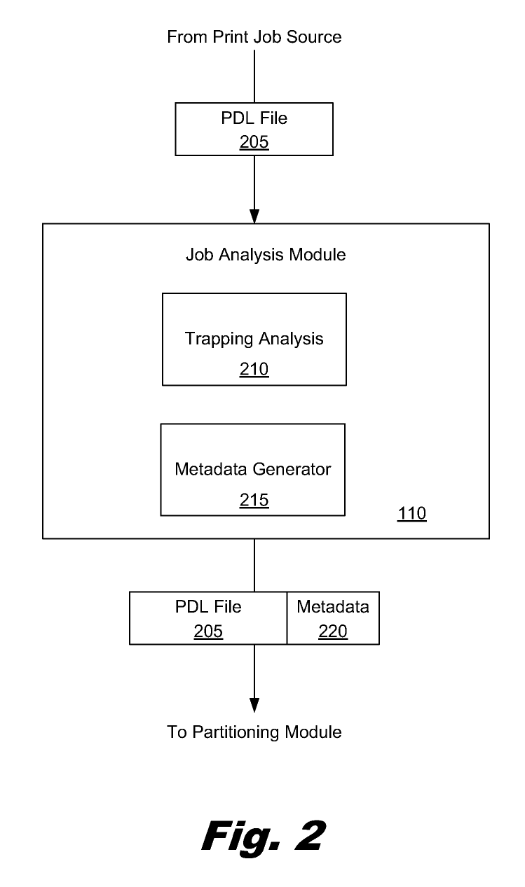

FIG. 2 is a block diagram of a more detailed view of an illustrative job analysis module (110) for the printing system (100) described in FIG. 1. As shown, the job analysis module (110) accepts a page description language file (205) as input. The page description language file may be in any page description language that suits a particular application of the principles of the present specification. Examples of suitable page description languages include, but are not limited to, Printer Command Language (PCL), Portable Document Format (PDF), PostScript, HP-GL, Scalable Vector Graphics (SVG), XML Paper Specification (XPS), Advanced Function Presentation (AFP), and the like.

The job analysis module (110) includes a trapping analysis submodule (210) and a metadata generator submodule (215). The trapping analysis analyzes each page of the received page description language file (205) to determine whether trapping is to be performed on that page at the raster image processing stage. Various methods of determining when and how to trap objects within a page description language file may be used. A determination of whether trapping is to be performed on a page may include (1) identifying the objects specified by the page description language file for that page; (2) identifying the color space of each object; and (3) identifying objects on the page, if any, that overlap or abut each other. In the event that two abutting or overlapping objects on the page are to be printed as different spot colors, trapping will be performed for that page. If the two abutting or overlapping objects are to be printed as processed colors, average color values may be computed around the abutting or overlapping the objects to determine whether the objects are subject to trapping.

The results of the trapping analysis performed for each of the pages may be attached or appended to the page description language file (205) as metadata (220) by the metadata generator submodule (215). Additionally or alternatively, the results of the trapping analysis performed for each of the pages may be stored in a database or other system which allows the results of each page to be associated with that page and referenced by a processor, machine, or module of the system for printing the file (205). In certain examples, the job analysis module (110) may also determine, for each page, a ratio of the area of trapping versus the area of the entire page. By compiling this data for each page, an indication of the relative complexity of each page and the print job as a whole may be determined. When included in the metadata (220), this data may be useful to the partitioning module (115, FIG. 1) in distributing the print job among the raster image processors.

Additionally, other data relating to the complexity of the pages and the print job in general may be determined by the job analysis module (110) and included in the metadata for the page description language file. For example, information about the transparency of page objects, the size of images, the resolution of images, the use of fonts, and/or the like may also be analyzed by the job analysis module (110) and included in the metadata for use by the partitioning module (115, FIG. 1) in partitioning the print job and distributing the partitions among the raster image processors (135-1 to 135-N). As shown in FIG. 2, the output of the job analysis module (110) to the partitioning module (115, FIG. 1) may include the page description language file (205) with the appended metadata (220).

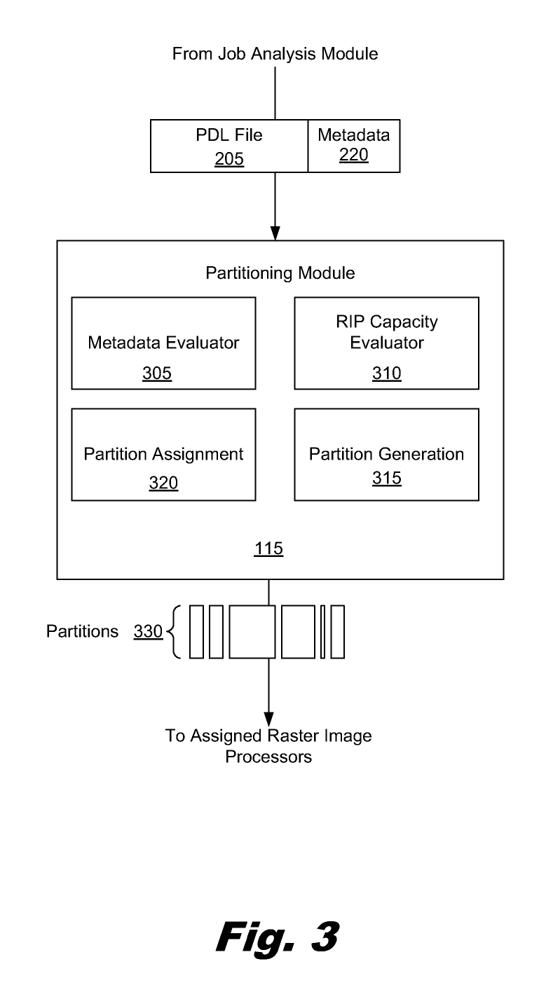

FIG. 3 is a block diagram of a more detailed view of an example of the job partitioning module (115) of the printing system (100) described in FIG. 1. The job partitioning module (115) of the present example includes a metadata evaluator submodule (305), a raster image processing capacity evaluator submodule (310), a partition generation submodule (315), and a partition assignment submodule (320).

The metadata evaluator submodule (305) examines the metadata (220) received with the page description language file (205) to identify which of the pages in the print job are marked for trapping, and any other information included in the metadata that may be pertinent to the partitioning and distribution of the print job. The raster image processing capacity evaluator submodule (310) may identify which of the raster image processors (135-1 to 135-N) of the raster image processing module (120, FIG. 1) is available for use in processing the present print job, the capacity of each available raster image processor (135-1 to 135-N), and the total capacity of the raster image processors (135-1 to 135-N) acting in parallel.

Based on at least the trapping information in the metadata (220) and the raster image processing capacity evaluator submodule (310), the partition generation submodule (315) divides the page description language file into partitions (330), and the partition assignment submodule (320) allocates each partition (330) to one of the parallel raster image processors (135-1 to 135-N) of the raster image processing module (120). As described above, the partition generation submodule (315) and the partition assignment submodule (320) may allocate the partitions (330) to the raster image processors (135-1 to 135-N) in such a way that raster image processing efficiency is optimized. In this way, raster image processing may be performed for the print job at a speed that is greater than or equal to the printing speed of the printing device (130).

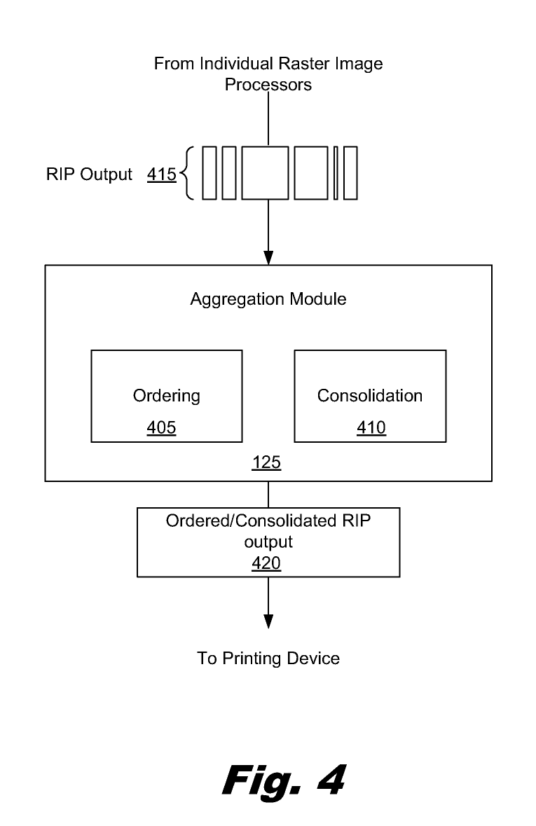

FIG. 4 is a block diagram of a more detailed view of an illustrative aggregation module (125) for the printing system (100) described in FIG. 1. The illustrative aggregation module (125) of the present example includes an ordering submodule (405) and a consolidation submodule (410). As raster image processing (including trapping) is performed in parallel on the partitions (330, FIG. 3) of the page description language file (205), each raster image processor (135-1 to 135-N) provides its individual output (415) for the partition(s) it processes to the aggregation module (125). All of this output (415) is collected and arranged in a consecutive order indicative of the original order of pages in the page description language file (205) by the ordering submodule (405). The consolidation submodule (410) may consolidate the output (415) from the raster image processors (135-1 to 135-N) into a single raster file (420) which is provided to the printing device (130).

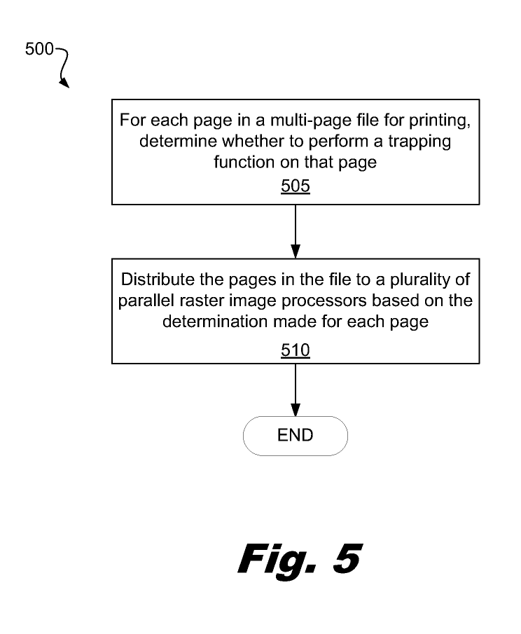

FIG. 5 is a flowchart diagram of an illustrative method (500) of processing a file for printing according to the principles of the present specification. According to the method (500), for each page in a multi-page file to be printed, a determination is made (block 505) as to whether to perform a trapping a function on that page. Once the determination has been made for each page, the pages of the file are distributed (block 510) among a plurality of parallel raster image processors based on the determination made for each page with regard to trapping. In this way, in systems performing trapping at the raster image processing level may allocate more raster image processing resources to the pages of the file indicated for trapping, thereby increasing raster image processing speed and efficiency. As part of the process of distributing the pages among the raster image processors, the page description file may be divided into a plurality of partitions based on the trapping determination for each page.

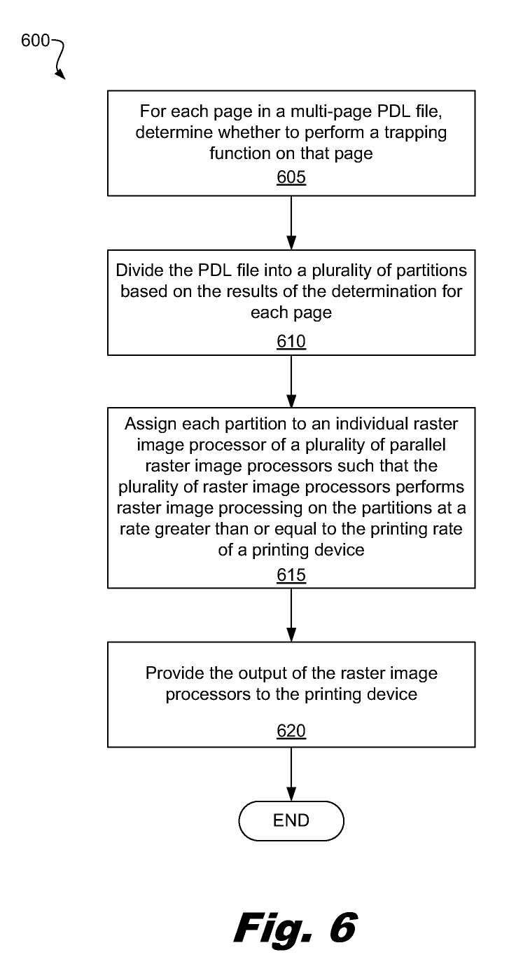

FIG. 6 is a flowchart diagram of another illustrative method (600) of processing a file for printing according to the principles of the present specification. According to the method (600) of FIG. 6, for each page in a multi-page page description language file, a determination is made (block 605) of whether to perform a trapping function on that page. The page description language file is then divided (block 610) into a plurality of partitions based on the results of the determination made for each page. In certain examples, the partitioning may be performed such that pages not indicated for trapping are included in larger partitions, and pages indicated for trapping are included in smaller partitions. The results of the determination may be appended to or otherwise associated with the page description language file as metadata.

Each partition is then assigned (block 615) to an individual raster image processor of a plurality of parallel raster image processors such that the plurality of raster image processors collectively perform raster image processing on the partitions at a rate greater than or equal to the printing rate of a printing device. The output of the raster image processors is provided (block 620) to the printing device for printing. In certain examples, the output of the raster image processors is first arranged into a consecutive order indicative of the order of the pages in the page description language file prior to being sent to the printing device.

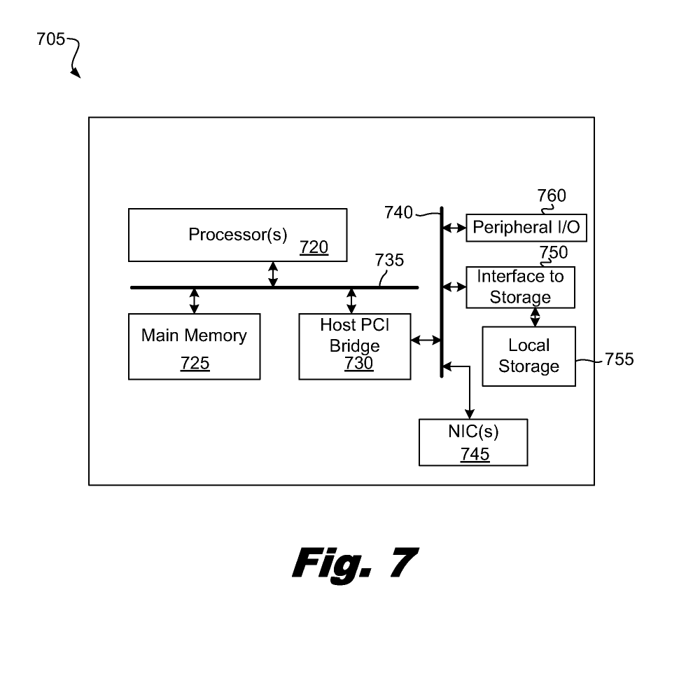

FIG. 7 is a block diagram of an illustrative computing device (705) that may be used to implement any of the devices, modules, submodules, or raster image processors described in the previous Figures consistent with the principles of the present specification. In certain examples, the same computing device (705) may implement multiple modules, submodules, and/or raster image processors. Additionally or alternatively, certain modules, submodules, and/or raster image processors may be separately implemented by individual computing devices (705).

In this illustrative device (705), an underlying hardware platform executes machine-readable instructions to exhibit a desired functionality. For example, if the illustrative device (705) implements the modules (110, 115, 120, 125) of FIG. 1, the machine-readable instructions may include at least instructions for receiving a file having multiple pages to be printed; determining, for each page in the file, whether to perform a trapping function on that page; dividing the file into multiple partitions based on the trapping determination made for each page; distributing the partitions among multiple parallel raster image processors; and providing the output of the multiple parallel raster image processors to a printing device.

The hardware platform of the illustrative device (705) may include at least one processor (720) that executes code stored in the main memory (725). In certain examples, the processor (720) may include at least one multi-core processor having multiple independent central processing units (CPUs), with each CPU having its own L1 cache and all CPUs sharing a common bus interface and L2 cache. Additionally or alternatively, the processor (720) may include at least one single-core processor.

The at least one processor (720) may be communicatively coupled to the main memory (725) of the hardware platform and a host peripheral component interface bridge (PCI) (730) through a main bus (735). The main memory (725) may include dynamic non-volatile memory, such as random access memory (RAM). The main memory (725) may store executable code and data that are obtainable by the processor (720) through the main bus (735).

The host PCI bridge (730) may act as an interface between the main bus (735) and a peripheral bus (740) used to communicate with peripheral devices. Among these peripheral devices may be one or more network interface controllers (745) that communicate with one or more networks, an interface (750) for communicating with local storage devices (755), and other peripheral input/output device interfaces (760).

The configuration of the hardware platform of the device (705) in the present example is merely illustrative of one type of hardware platform that may be used in connection with the principles described in the present specification. Various modifications, additions, and deletions to the hardware platform may be made while still implementing the principles described in the present specification. For instance, it may be suitable in certain examples to implement one or more of the modules, submodules, or raster image processors of the preceding Figures as application-specific circuitry instead of as a processor that executes machine-readable code. In still other examples, a hybrid approach may be taken such that one or more of the modules, submodules, or raster image processors of the preceding Figures is implemented by a combination of application-specific circuitry and a processor executing machine-readable code.

The preceding description has been presented only to illustrate and describe examples and examples of the principles described. This description is not intended to be exhaustive or to limit these principles to any precise form disclosed. Many modifications and variations are possible in light of the above teaching.

What is claimed is:

1. A computer-implemented method of processing a file comprising a plurality of pages for printing, said method comprising:
for each page in said file, determining with at least one processor whether to perform a trapping function on that said page; and
distributing said pages in said file among a plurality of parallel raster image processors based on said determination for each said page of whether to perform said trapping function.

2. The method of claim 1, further comprising dividing said file into a plurality of partitions based on said determination for each said page of whether to perform said trapping function.

3. The method of claim 1, in which said raster image processors perform said trapping function on each said page indicated by said determination.

4. The method of claim 1, further comprising sending an output of said plurality of raster image processors to a printing device.

5. The method of claim 4, in which said pages in said file are distributed to said plurality of parallel raster image processors such that said parallel raster image processors perform raster image processing on said pages at a rate that is greater than or equal to a rate at which said printing device is able to print said pages.

6. A computer-implemented method of printing a page description language file comprising a plurality of pages, said method comprising:
for each page in said page description language file, determining with at least one processor whether to perform a trapping function on that page based on a content of that page;
dividing said page description language file into a plurality of partitions with said at least one processor based on said determination for each said page of whether to apply trapping; and
assigning each said partition to one individual raster image processor in a plurality of individual raster image processors such that said plurality of raster image processors performs raster image processing on said partitions at a rate greater than or equal to a printing rate of a printing device receiving an output of said raster image processors.

7. The method of claim 6, further comprising receiving an output of said plurality of raster image processors and arranging said output in a consecutive order corresponding to an original order of said pages in said page description language file.

8. The method of claim 7, further comprising sending the output from the plurality of raster image processors to said printing device in said consecutive order.

9. The method of claim 6, in which each said partition comprises at least one said page of said page description language file.

10. The method of claim 6, further comprising associating an indication of said determination for each said page of whether to perform said trapping function with said page description language file.

11. A printing system, comprising:
at least one processor;
a memory communicatively coupled to said at least one processor, said memory storing executable code that causes said at least one processor, upon executing said executable code, to:
receive a file comprising a plurality of pages;
for each page in said file, determine whether to perform a trapping function on that said page; and
distribute said pages in said file among a plurality of parallel raster image processors based on said determination for each said page of whether to perform said trapping function.

12. The system of claim 11, said executable code further causing said at least one processor to divide said file into a plurality of partitions based on said determination for each said page of whether to perform said trapping function.

13. The system of claim 11, in which said raster image processors perform said trapping function on each said page indicated by said determination.

14. The system of claim 11, said executable code further causing said at least one processor to send an output of said plurality of raster image processors to a printing device.

15. The system of claim 14, in which said pages in said file are distributed to said plurality of parallel raster image processors such that said parallel raster image processors perform raster image processing on said pages at a rate that is greater than or equal to a rate at which said printing device is able to print said pages.
